(19) United States
(12) Patent Application Publication
(10) Pub. No.: US 2022/0402231 A1
(43) Pub. Date: Dec. 22, 2022

(54) CORRUGATED FIBERBOARD SHEET MANUFACTURING APPARATUS

(71) Applicant: Rengo Co., Ltd., Osaka (JP)

(72) Inventors: Takuji YANO, Osaka (JP); Hiroshi TAHARA, Osaka (JP)

(21) Appl. No.: 17/641,750

(22) PCT Filed: Sep. 2, 2020
(86) PCT No.: PCT/JP2020/033242

§ 371 Date: Mar. 9, 2022

(30) Foreign Application Priority Data
Sep. 10, 2019 (JP) 2019-164415

(51) Int. Cl. B31F 1/28

(52) U.S. Cl. CPC B31F 1/285; B31F 1/2831

(57) ABSTRACT

“A controller of a corrugated fiberboard sheet manufacturing apparatus can execute a steady operation where a corrugating roll rotates at a first set speed, a deceleration operation where the corrugating roll is decelerated to a second set speed, and an acceleration operation where the corrugating roll is accelerated to a third set speed. In the steady operation, the controller set an on-off valve to a closed state for steam supply to a hollow portion at a first set pressure by a pressure adjusting valve. In the deceleration operation, the controller maintains states of the valves. In the acceleration operation, the controller switches the on-off valve to an open state, and adjusts the pressure adjusting valve for steam supply to the hollow portion at a second set pressure.”

### TECHNICAL FIELD

The present invention relates to a corrugated fiberboard sheet manufacturing apparatus.

### BACKGROUND ART

A corrugated fiberboard sheet is formed of a outer liner, a inner liner, and a corrugating medium formed into a wave form existing therebetween. A plurality of projections and recesses provided in the corrugating medium are formed when corrugating medium base paper is fed by a pair of corrugating rolls during the production of the corrugated fiberboard sheet. The corrugating roll is provided with heating means because it is necessary to gelatinize a starch glue applied to tops of the projections when adhering the corrugating medium base paper to first liner base paper. As the heating means, there are a configuration in which an electric heater is disposed on a corrugating roll and a. configuration in which high-temperature and high-pressure steam is retained in the corrugating roll, but the latter is more effective in terms of cost than the former.

When steam is used for heating, condensation liquid water accumulated in the corrugating roll hinders the heating by the steam, so that the heating efficiency is lowered and poor adhesion of the corrugating medium base paper to the liner base paper occurs. In addition, when the corrugating roll is stopped, since the temperature of a lower part where the condensation liquid water is accumulated becomes lower than the temperature of an upper part, and .a temperature distribution in a circumferential direction of the corrugating roll becomes uneven, immediately after the start of operation, poor adhesion of the corrugating medium base paper to the liner base paper occurs.

Patent Document 1 discloses a corrugated fiberboard sheet pmanufacturing apparatus including an on-off valve in which one end side is connected to a corrugating roll and the other end side is connected to a low pressure portion. In this manufacturing apparatus, the on-off valve is switched from a closed state to an open state, the condensation liquid water in the corrugating roll is forcibly discharged, and the inside of the corrugating roll is replaced with high-temperature and high-pressure steam, and thereby a decrease in the heating efficiency of the corrugating roll is suppressed.

Patent Document 2 discloses a corrugated fiberboard sheet manufacturing apparatus including a pressure adjusting valve that adjusts a steam supply pressure interposed between a boiler and a corrugating roll. In this manufacturing apparatus, the pressure adjusting valve increases the supply pressure of steam to the corrugating roll at the start of operation, and supplies a large amount of steam into the corrugating roll to alleviate the unevenness of the temperature distribution that occurs when the operation is stopped.

### PRIOR ART DOCUMENT

### Patent Document

Patent Document 1: JP 5199586 B

Patent Document 2: JP 4558566 B

### SUMMARY OT THE INVENTION

### Problems to be Solved by the Invention

In this type of corrugated fiberboard sheet manufacturing apparatus, when the amount of roll-shaped liner base paper or corrugating medium base paper hung on a mill roll stand is small, it is necessary to splice the base paper hung on another mill roll stand to the end of the base paper (this operation is called “paper splicing”). In order to prevent a decrease in production efficiency, the paper splicing is performed in a state where the feeding speed of the base paper by the corrugating roll is reduced without stopping the manufacturing apparatus.

In addition, when the manufacturing of a predetermined lot is completed, only one of the liner base paper and the corrugating medium base paper may be replaced with base paper having a different basis weight (mass per unit area) or grade, and a different lot may be manufactured (this operation is called “lot change”). Similar to the paper splicing, this lot change is performed by splicing the next base paper to the previous base paper in a state where the feeding speed of the base paper by the corrugating roll is reduced without stopping the manufacturing apparatus.

In order to reduce the feeding speed of the base paper, it is necessary to reduce the rotation of the corrugating roll. In this case, since a centrifugal force acting on the condensation liquid water in the corrugating roll becomes small, the state of adhesion of the condensation liquid water to the wall surface of a hollow portion in the corrugating roll also changes. Depending on the state of adhesion, the condensation liquid water may not be sufficiently discharged, and the residual amount of the condensation liquid water in the hollow portion may increase. In this case, when the paper splicing or lot change is completed and the rotation of the corrugating roll (feeding speed of the base paper) is increased, since a layer (film thickness) due to the condensation liquid water becomes thick and the heating of the corrugating roll by steam is hindered, there is a risk of poor adhesion of the corrugating medium base paper to the liner base paper. No consideration is given to the poor adhesion at this time in the corrugated fiberboard sheet manufacturing apparatus of Patent Documents 1 and 2.

An object of the present invention is to provide a corrugated fiberboard sheet manufacturing apparatus capable of suppressing poor adhesion that may occur when the rotation of a corrugating roll is decelerated from that in steady operation and then accelerated again.

### Means for Solving the Problems

According to one aspect of the present invention, there is provided a corrugated fiberboard sheet manufacturing apparatus comprising: a corrugating roll that has a hollow portion capable of retaining steam, forms a plurality of projections and recesses alternately on a strip-shaped corrugating medium base paper, and crimps the corrugating medium base paper onto a strip-shaped liner base paper to feed; a drive unit that rotates the corrugating roll; a glue unit that applies glue to a top of the projection of the corrugating medium base paper for adhering to the liner base paper; a pressure adjusting valve that communicates with the hollow portion of the corrugating roll and adjusts a supply pressure of steam supplied from a steam supply unit to the hollow portion; a steam trap that communicates with the hollow portion and discharges the condensation liquid water in the hollow portion; an on-off valve that has a first end that communicates with the hollow portion and a second end that communicates with a low pressure portion having a pressure lower than the pressure inside the hollow portion, and is capable of switching between an open state in which a first end side and a second end side communicate with each other and a closed state in which communication between the first end side and the second end side is cut off; and a control unit that controls the drive unit, the pressure adjusting valve, and the on-off valve, and feeds the corrugating medium base paper while heating the glue applied to the corrugating medium base paper with the steam through the corrugating roll, wherein the control unit is capable of executing a steady operation in which the corrugating roll is rotated at a first set speed by the drive unit, subsequently, executing a deceleration operation by the drive unit in which the corrugating roll is decelerated to a second set speed slower than the first set speed, and then executing an acceleration operation in which the corrugating roll is accelerated to a third set speed faster than the second set speed, in the steady operation, the control unit controls the pressure adjusting valve so that the on-off valve is in a closed state and the steam is supplied to the hollow portion at a first set pressure, in the deceleration operation, the control unit maintains a state of the on-off valve and the pressure adjusting valve, and in the acceleration operation, the control unit switches the on-off valve from a closed state to an open state, and adjusts the pressure adjusting valve so that the steam is supplied to the hollow portion at a second set pressure higher than the first set pressure.

In steady operation, steam is supplied to the hollow portion at the first set pressure by the pressure adjusting valve, and the starch glue is heated via the corrugating roll to gelatinize the starch glue, and the corrugating medium base paper is adhered to the liner base paper. The water condensed in the hollow portion is discharged through the steam trap communicating with the hollow portion.

When performing paper splicing or lot change, the steady operation is switched to the deceleration operation, and when the paper splicing or the lot change is completed, the deceleration operation is switched to the acceleration operation. Since the paper splicing and the lot change are performed in a state where the rotation of the corrugating roll corresponding to the feeding speed of the base paper is decelerated without stopping the corrugating roll (manufacturing apparatus), it is possible to suppress a decrease in the production efficiency of the corrugated fiberboard sheet.

In the acceleration operation, the on-off valve is switched from the closed state to the open state, and steam is supplied to the corrugating roll at the second set pressure of high pressure by the pressure adjusting valve. As a result, even if the amount of condensation liquid water remaining in the hollow portion of the corrugating roll increases, since the condensation liquid water containing steam in the hollow portion can be forcibly discharged through the on-off valve, and high-temperature and high-pressure steam can be supplied to the hollow portion, the corrugating roll can be quickly heated to the desired amount of heat. Therefore, since the starch glue applied to the corrugating medium base paper can be reliably heated via the corrugating roll, poor adhesion between the liner base paper and the corrugating medium base paper can be suppressed. In addition, it is possible to increase the operating speed of the manufacturing apparatus, that is, to improve the productivity of the corrugated fiberboard sheet.

### EFFECT OF THE INVENTION

In the corrugated fiberboard sheet manufacturing apparatus of the present invention, it is possible to suppress poor adhesion that may occur when the rotation of a corrugating roll is decelerated from that in steady operation and then accelerated again.

### BRIEF DESCRIPTION OF THE DRAWINGS

FIG. 1 is a schematic view illustrating a corrugated fiberboard sheet manufacturing apparatus according to an embodiment of the present invention;

FIG. 2 is a cross-sectional view of the manufactured corrugated fiberboard sheet;

FIG. 3 is a schematic view illustrating a single facer of the corrugated fiberboard sheet manufacturing apparatus of FIG. 1;

FIG. 4 is a cross-sectional view of a corrugating roll;

FIG. 5 is a pipe diagram of a heating mechanism of the corrugating roll;

FIG. 6 is a time chart illustrating a feeding speed of a first liner base paper, a corrugating medium base paper, and a single-faced corrugated fiberboard;

FIG. 7 is a time chart illustrating changes in a rotation speed of an upper corrugating roll;

FIG. 8A is a cross-sectional view illustrating a state of condensation liquid water in a stopped corrugating roll;

FIG. 8B is a cross-sectional view illustrating a state of condensation liquid water in a rotated corrugating roll;

FIG. 8C is a cross-sectional view illustrating a state of condensation liquid water in a corrugating roll that rotates at a higher speed than that of FIG. 8B;

FIG. 8D is a cross-sectional view illustrating a state of condensation liquid water in a corrugating roll that rotates at a higher speed than that of FIG. 8C;

FIG. 9 is a schematic view of a steam supply apparatus;

FIG. 10 is a block diagram of a corrugated fiberboard sheet manufacturing apparatus; and

FIG. 11 is a flowchart illustrating control by a control device.

### DESCRIPTION OF EMBODIMENTS

Hereinafter, embodiments of the present invention will be described with reference to the drawings.

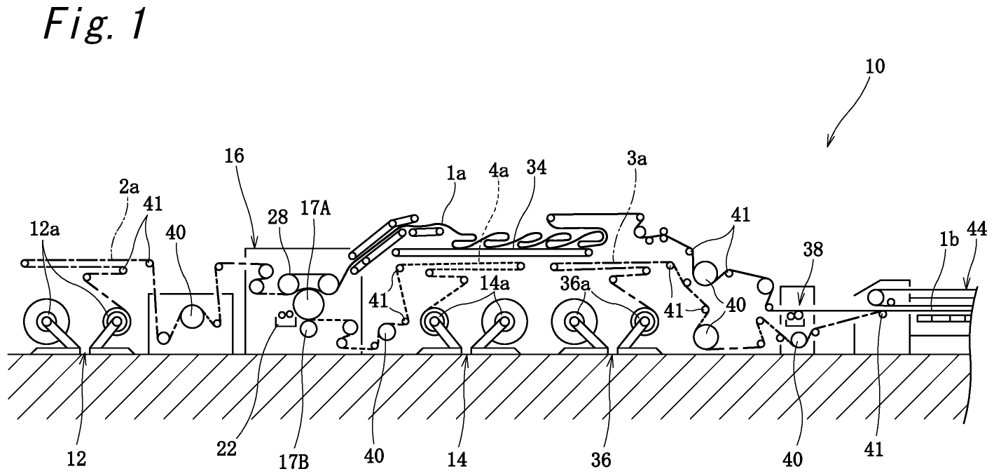

FIG. 1 illustrates a corrugator 10 which is a corrugated fiberboard sheet manufacturing apparatus according to an embodiment of the present invention. The corrugator 10 includes a first paper feed unit 12, a second paper feed unit 14, a single facer 16, a storage part 34, a third paper feed unit 36, a glue unit 38, and a double facer 44. Further, the corrugator 10 includes a plurality of heating rolls 40 and a plurality of guide rolls 41.

By the single facer 16, a first liner base paper 2a of the first paper feed unit 12 and a corrugating medium base paper 4a of the second paper feed unit 14 are crimped and adhered to form a strip-shaped single-faced corrugated fiberboard la. Subsequently, the double facer 44 presses and adheres a single-faced corrugated fiberboard 1a of the storage part 34 and a second liner base paper 3a of a third paper feed unit 36 to form a strip-shaped double-faced corrugated fiberboard 1b . Finally, a strip-shaped double-faced corrugated fiberboard 1b is cut into a corrugated fiberboard sheet 1 having a predetermined size by a cutter (not shown) disposed on the downstream side of the double facer 44.

During this steady operation, when the first liner base paper 2a or the corrugating medium base paper 4a is spliced or lot-changed, a deceleration operation is performed to reduce the feeding speed of these base papers 2a and 4a . When the paper splicing or lot change is completed, the deceleration operation is followed by the acceleration operation in which the feeding speed of the base papers 2a and 4a is increased. When the acceleration operation is completed, it returns to the steady operation.

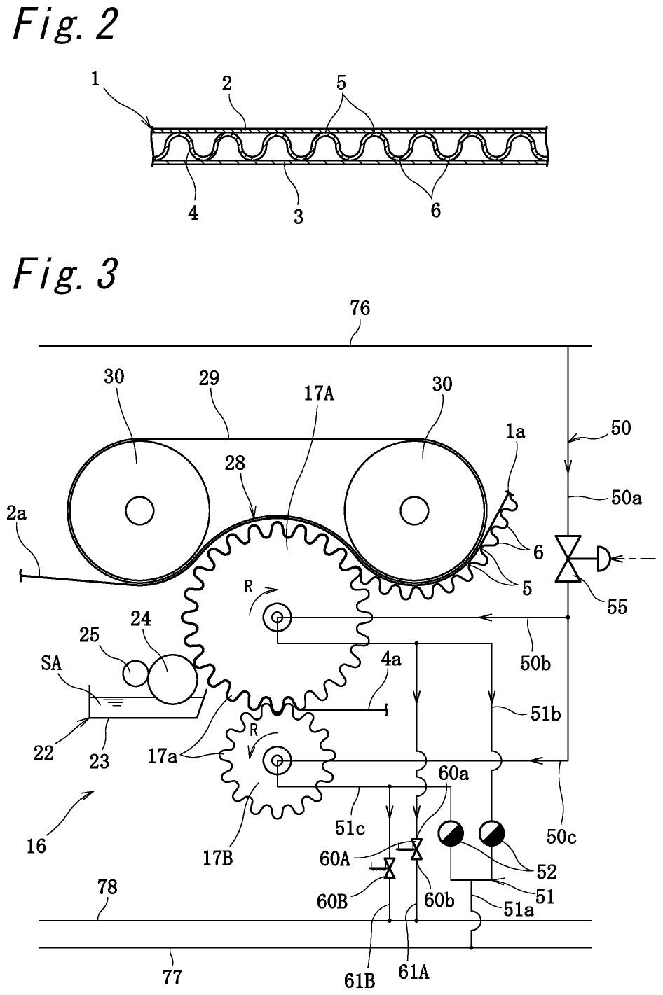

As illustrated in FIG. 2, the corrugated fiberboard sheet 1 manufactured by the corrugator 10 is formed of a outer liner 2, a inner liner 3, and a corrugating medium 4 formed into a wave form existing therebetween. At least the liners 2 and 3 and the corrugating medium 4 often differ in at least one of grade and basis weight (mass per unit area). In the present embodiment, the outer liner 2 is formed of a first liner base paper 2a and the inner liner 3 is formed of the second liner base paper 3a ; however, the outer liner 2 may be formed of the second liner base paper 3a and the inner liner 3 may be formed of the first liner base paper 2a.

The corrugating medium 4 includes a plurality of projections 5 and recesses 6. The projections 5 and recesses 6 extend in the direction perpendicular to the paper surface of FIG. 2, and are formed alternately in a left-right direction in FIG. 2. The top of the projection 5 is adhered to the outer liner 2, and the top of the recess 6 is adhered to the inner liner 3.

As illustrated in FIG. 1, the first paper feed unit 12 is formed of two mill roll stands 12a . The roll-shaped first liner base paper 2a is hung on each of the mill roll stands 12a . The first liner base paper 2a of one of the mill roll stands 12a located on the right side in FIG. 1 is unwound by the drive of the single facer 16. The first liner base paper 2a of the other mill roll stand 12a located on the left side in FIG. 1 is used by paper splicing or changing lot without being unwound by the drive of the single facer 16.

The second paper feed unit 14 is formed of two mill roll stands 14a. A roll-shaped corrugating medium base paper 4a is hung on each of the mill roll stands 14a. The corrugating medium base paper 4a of one of the mill roll stands 14a located on the left side in FIG. 1 is unwound by the drive of the single facer 16. The corrugating medium base paper 4a of the other mill roll stand 14a located on the right side in FIG. 1 is used by paper splicing or changing lots without being unwound by the drive of the single facer 16.

The single facer 16 includes a pair of corrugating rolls 17A and 17B for feeding the corrugating medium base paper 4a, a glue unit 22 for applying a starch glue SA to the corrugating medium base paper 4a, and a crimping portion 28 that crimps the first liner base paper 2a and the corrugating medium base paper 4a.

Referring to FIG. 3, the pair of corrugating rolls 17A and 17B includes a plurality of teeth 17a that mesh with each other. The teeth 17a extend in an axial direction of the corrugating rolls 17A and 17B, and are arranged side by side in the circumferential direction of the corrugating rolls 17A and 17B. In the present embodiment, a diameter of an upper corrugating roll 17A located on the upper side is larger than a diameter of A lower corrugating roll 17B located on the lower side.

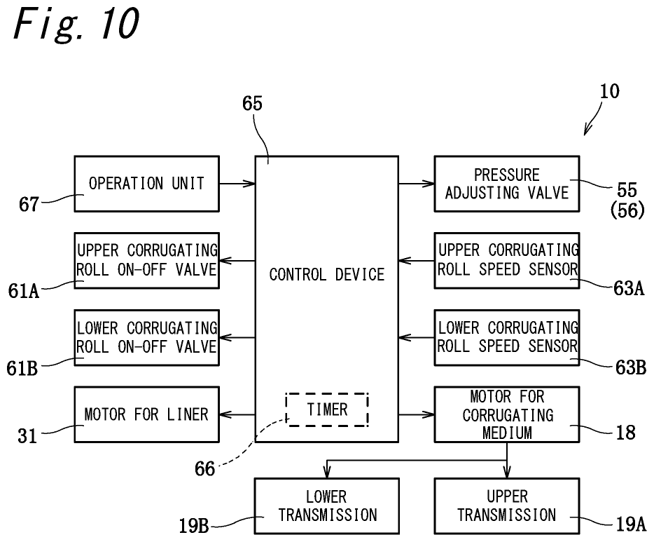

Referring to FIG. 10, the corrugating rolls 17A and 17B are rotated by the drive of a motor (drive unit) 18 via transmissions 19A and 19B. In FIG. 3, the upper corrugating roll 17A is rotated clockwise and the lower corrugating roll 17B is rotated counterclockwise, so that the corrugating medium base paper 4a is fed at a predetermined speed. In addition, a plurality of projections 5 and recesses 6 are alternately formed on the corrugating medium base paper 4a by the teeth 17a.

Subsequently, referring to FIG. 3, the glue unit 22 is disposed on the downstream side of a portion where the pair of corrugating rolls 17A and 17B mesh with each other in the feeding direction of the corrugating medium base paper 4a. The glue unit 22 includes a glue pan 23 having an upper end opening for storing the starch glue SA, an application roll 24, and a doctor roll 25. The glue unit 22 applies the starch glue SA to the top of the projection 5 of the corrugating medium base paper 4a . The application roll 24 is disposed adjacent to the upper corrugating roll 17A so that the lower portion is immersed in the starch glue SA in the glue pan 23 and a part in the circumferential direction is in sliding contact with the top of the projection 5. The application roll 24 may be a drive type roll that rotates with a motor, or a driven type roll that is rotated by sliding contact with the corrugating medium base paper 4a . The doctor roll 25 is disposed on the application roll 24 in a pressure-welded state, and the excess starch glue SA applied to the surface of the application roll 24 is scraped off and returned to the glue pan 23.

The crimping portion 28, is disposed on the downstream side of the glue unit 22 in the feeding direction of the corrugating medium base paper 4a . The crimping portion 28 includes a crimping member 29 crimped to the upper corrugating roll 17A at a predetermined pressure. The crimping member 29 of the present embodiment is a belt, which is erected between a pair of tension rolls 30. Of the pair of tension rolls 30, one is a drive type roll that rotates with a motor 31 (refer to FIG. 10), and the other is a driven type roll that is rotated by a crimping member 29. By the rotation of the upper corrugating roll 17A and the crimping member 29, the first liner base paper 2a is crimped to the top of the projection 5 of the corrugating medium base paper 4a and is fed to the downstream side.

The crimping portion 28 may be formed of one press roll instead of the crimping member 29 formed of a belt and the pair of tension rolls 30, or may be formed of two press rolls arranged at intervals in the circumferential direction of the upper corrugating roll 17A.

As illustrated in FIG. 1, the storage part 34 is formed of a canvas belt capable of transporting the single-faced corrugated fiberboard 1a to which the first liner base paper 2a and the corrugating medium base paper 4a are adhered to the double facer 44 side.

The third paper feed unit 36 is formed of two mill roll stands 36a . The roll-shaped second liner base paper 3a is hung on each of the mill roll stands 36a . The second liner base paper 3a of one of the mill roll stands 36a located on the right side in FIG. 1 is unwound by the drive of the double facer 44. The second liner base paper 3a of the other mill roll stand 36a located on the left side in FIG. 1 is used by paper splicing or lot-changed without being unwound by the drive of the double facer 44.

Similar to the glue unit 22, the glue unit 38 includes a container with an upper end opening for storing starch glue, an application roll, and a doctor roll, and applies the starch glue to the top of the recess 6 of the corrugating medium base paper 4a in the single-faced corrugated fiberboard la.

The double facer 44 is formed of a heating part and a cooling part, and feeds the single-faced corrugated fiberboard 1a and the second liner base paper 3a while heating and pressurizing them to form a strip-shaped double-faced corrugated fiberboard 1b.

By driving the motors 18 and 31 (refer to FIG. 10), the pair of corrugating rolls 17A and 17B rotate and the crimping member 29 rotates. As a result, the first liner base paper 2a hung on the mill roll stand 12a and the corrugating medium base paper 4a hung on the mill roll stand 14a are fed while being guided by the heating roll 40 and the guide roll 41.

When passing between the pair of corrugating rolls 17A and 17B, the projections 5 and recesses 6 are formed on the corrugating medium base paper 4a along the shape of the teeth 17a . The corrugating medium base paper 4a is delivered to the downstream side in a state of being in close contact with the surface of the upper corrugating roll 17A, and when passing through the glue unit 22, starch glue SA is applied to the top of the projection 5. After that, the corrugating medium base paper 4a is adhered to the first liner base paper 2a when passing through the crimping portion 28, and is separated from the surface of the upper corrugating roll 17A after passing through the crimping portion 28 (refer to FIG. 3). The single-faced corrugated fiberboard 1a thus formed is fed onto the storage part 34.

By driving the double facer 44, the single-faced corrugated fiberboard 1a on the storage part 34 and the second liner base paper 3a hung on the mill roll stand 36a are fed while being guided by the heating roll 40 and the guide roll 41.

When passing through the glue unit 38, the starch glue SA is applied to the top of the recess 6 of the single-faced corrugated fiberboard la. Subsequently, in front of the double facer 44, the single-faced corrugated fiberboard 1a and the second liner base paper 3a are brought into close contact with each other to form the double-faced corrugated fiberboard 1b . The double-faced corrugated fiberboard 1b is heated and pressurized by passing through the double facer 44 to complete the adhesion.

Next, a heating mechanism for heating the corrugating medium base paper 4a via the pair of corrugating rolls 17A and 17B to gelatinize the applied starch glue SA will be described. The pair of tension rolls 30 of the crimping portion 28 and the plurality of heating rolls 40 are also provided with the same heating mechanism as the corrugating rolls 17A and 17B.

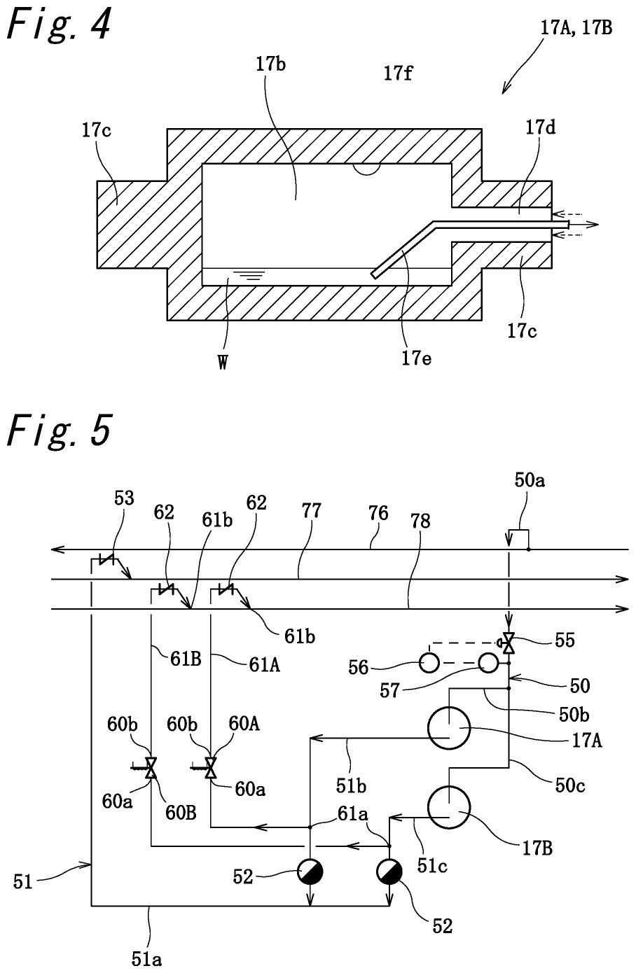

As illustrated in FIG. 4, the corrugating rolls 17A and 17B are hollow rolls provided with a hollow portion 17b capable of retaining steam inside. One of the pair of shaft portions 17c protruding from both ends is provided with a communication hole 17d that communicates with the hollow portion 17b. A siphon pipe 17e is disposed in the hollow portion 17b through the communication hole 17d. The siphon pipe 17e is fixed so as not to rotate even if the corrugating rolls 17A and 17B rotate, and the tip end thereof is disposed in the vicinity of the lower top of the hollow portion 17b.

Referring to FIGS. 3 and 5, a supply pipe 50 is connected to the communication hole 17d, and a discharge pipe 51 is connected to the siphon pipe 17e. Further, the discharge pipe 51 is provided with a steam trap 52 that discharges a liquid (condensation liquid water) generated in the hollow portion 17b due to the pressure in the hollow portion 17b.

The supply pipe 50 includes a base portion 50a connected to a steam supply pipe 76 that supplies high-temperature and high-pressure steam, and a first branch portion 50b and a second branch portion 50c that are bifurcated from the base portion 50a. The first branch portion 50b is connected to the upper corrugating roll 17A, and the second branch portion 50c is connected to the lower corrugating roll 17B.

The discharge pipe 51 includes the base portion 51a connected to a first drain recovery pipe 77, and the first branch portion 51 b and the second branch portion 51c that are bifurcated from the base portion 51a. The first branch portion 51b is connected to the siphon pipe 17e (refer to FIG. 4) of the upper corrugating roll 17A, and the second branch portion 51c is connected to the siphon pipe 17e (refer to FIG. 4) of the lower corrugating roll 17B.

The steam trap 52 is interposed between the first branch portion 51b and the second branch portion 51c , respectively. The steam trap 52 discharges the fluid in the hollow portion 17b due to the pressure difference (differential pressure) in the hollow portion 17b on the upstream side and in the first drain recovery pipe 77 on the downstream side. The base portion 51a is provided with a check valve 53 that allows the movement of fluid from the branch portions 51b and 51c toward the first drain recovery pipe 77 and prevents the movement of the fluid in an opposite direction.

The corrugating rolls 17A and 17B are heated by the high-temperature and high-pressure steam supplied from the steam supply pipe 76 into the hollow portion 17b . Therefore, the corrugating medium base paper 4a and the starch glue SA, which are in close contact with each other through the peripheral walls of the corrugating rolls 17A and 17B, can be heated. As a result, the starch glue SA can be gelatinized, so that the corrugating medium base paper 4a can be reliably adhered to the first liner base paper 2a.

Referring to FIG. 4, the steam supplied into the hollow portion 17b condenses due to heat exchange with the corrugating rolls 17A and 17B. The condensation liquid water containing steam is discharged to the first drain recovery pipe 77 through the siphon pipe 17e and the discharge pipe 51 by the differential pressure in the hollow portion 17b and the first drain recovery pipe 77.

However, if the pressure in the hollow portion 17b is lower than the pressure in the first drain recovery pipe 77, or if these differential pressures arelow, the condensation liquid water in the hollow portion 17b cannot be discharged to the first drain recovery pipe 77. Further, even if the differential pressure in the hollow portion 17b and the first drain recovery pipe 77 is within an appropriate range, it may be difficult to discharge the condensation liquid water depending on the rotation speed of the corrugating rolls 17A and 17B. The details are as follows.

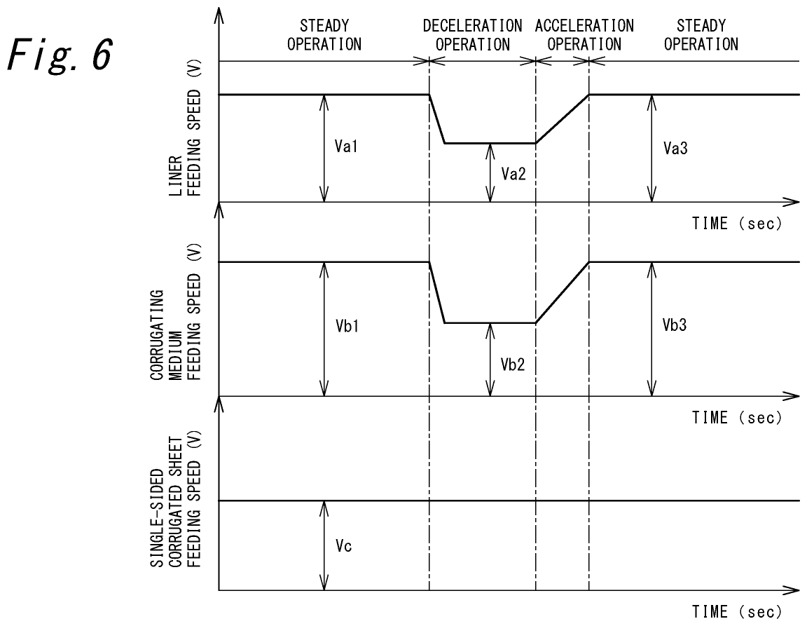

Referring to FIG. 6, a feeding speed Va of the first liner base paper 2a from the mill roll stand 12a, a feeding speed Vb of the corrugating medium base paper 4a from the mill roll stand 14a, and a feeding speed Vc of the single-faced corrugated fiberboard 1a from the single facer 16 is set based on a target production rate of the corrugated fiberboard sheet 1.

The feeding speed Va of the first liner base paper 2a corresponds to the production speed of the single-faced corrugated fiberboard 1a. The feeding speed Vb of the corrugating medium base paper 4a is faster than the feeding speed Va of the first liner base paper 2a, and is about 1.3 to 1.6 times the feeding speed Va. That is, since the amount of the corrugating medium base paper 4a used is larger than the amount used in the first liner base paper 2a, the frequency of paper splicing is usually higher in the corrugating medium base paper 4a than in the first liner base paper 2a . The feeding speed Vc of the single-faced corrugated fiberboard 1a corresponds to the production speed of the double-faced corrugated fiberboard 1b, and is slower than the feeding speed Va of the first liner base paper 2a.

In the single facer 16, when the base papers 2a and 4a are spliced or lot-changed, the feeding speed of the first liner base paper 2a and the corrugating medium base paper 4a is decelerated from Va1 and Vb1 in steady operation to Va2 and Vb2 (deceleration operation). When the paper splicing or lot change is completed, the feeding speed of the first liner base paper 2a and the corrugating medium base paper 4a is increased from Va2 and Vb2 to Va3 and Vb3 (acceleration operation). In the case of the paper splicing, the feeding speeds Va1 and Va3 and the feeding speeds Vb1 and Vb3 are often set to be the same. In the case of the lot change, the feeding speeds Va1 and Va3 and the feeding speeds Vb1 and Vb3 are often different depending on the grade and basis weight of the base papers 2a and 4a.

The feeding speed Vc of the single-faced corrugated fiberboard la is the same regardless of the change in the feeding speed Va (production speed of the single-faced corrugated fiberboard 1a) of the first liner base paper 2a. The feeding speed Vc of the single-faced corrugated fiberboard 1a is slower than the feeding speed Va of the first liner base paper 2a, and the formed single-faced corrugated fiberboard 1a is stored in the storage part 34, there is no need to perform the paper splicing (or lot change).

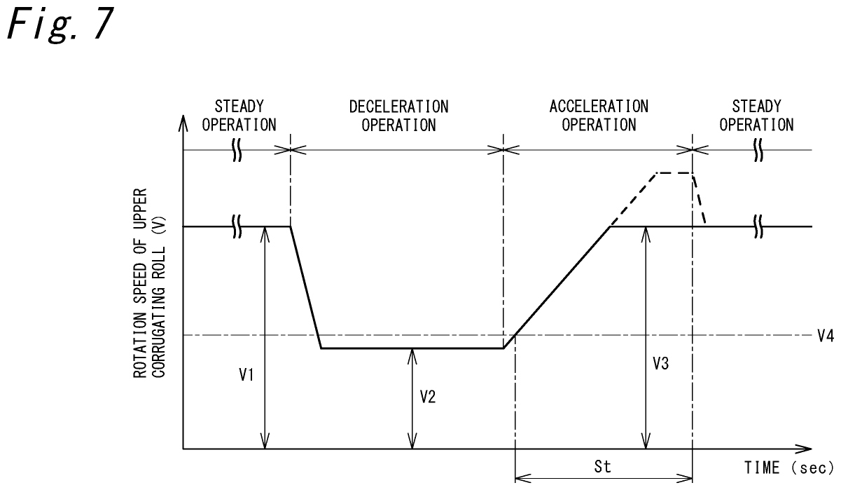

Referring to FIG. 7, the upper corrugating roll 17A is set with the rotation speeds V1 to V3 according to the feeding speeds Va1 to Va3 of the first liner base paper 2a. Specifically, the rotation speed of the upper corrugating roll 17A is set to the first set speed V1 during the steady operation, is set to the second set speed V2 during deceleration operation during paper splicing or lot change, and is set to the third set speed V3 during the acceleration operation after the completion of the paper splicing or lot change. The second set speed V2 is slower than the first set speed V1, and the third set speed V3 is faster than the second set speed V2. The first set speed V1 and the third set speed V3 may be the same as or different from each other.

The upper corrugating roll 17A has a long contact time with the corrugating medium base paper 4a and has the greatest effect on the gelatinization of the starch glue SA. Therefore, the set speeds V1 to V3 of the upper corrugating roll 17A are set, and the rotation speed of the other lower corrugating roll 17B and the rotation speed of the roll 30 of the crimping portion 28 are set based on the set speeds V1 to V3 of the upper corrugating roll 17A. However, the setting of the rotation speed of each roll is not limited thereto.

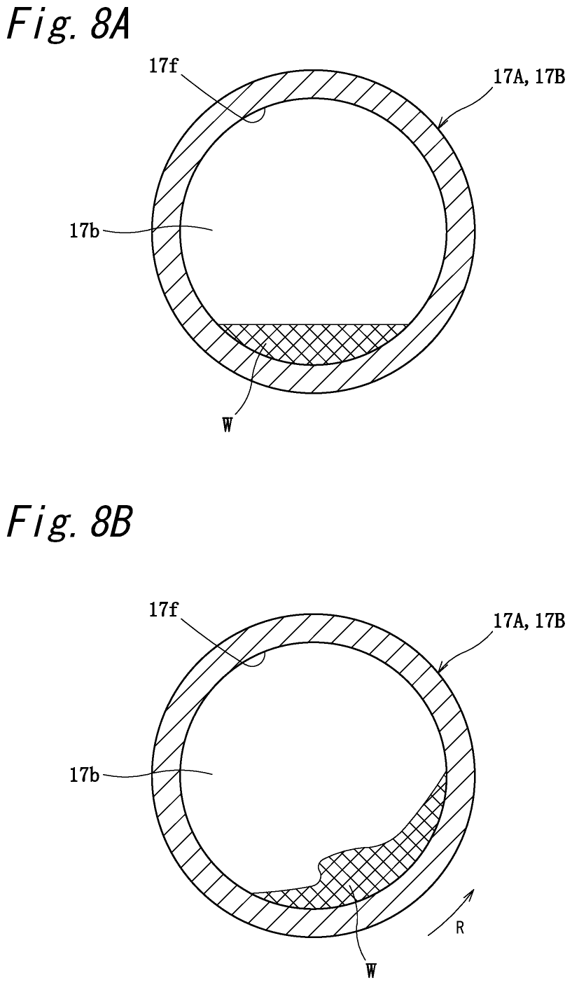

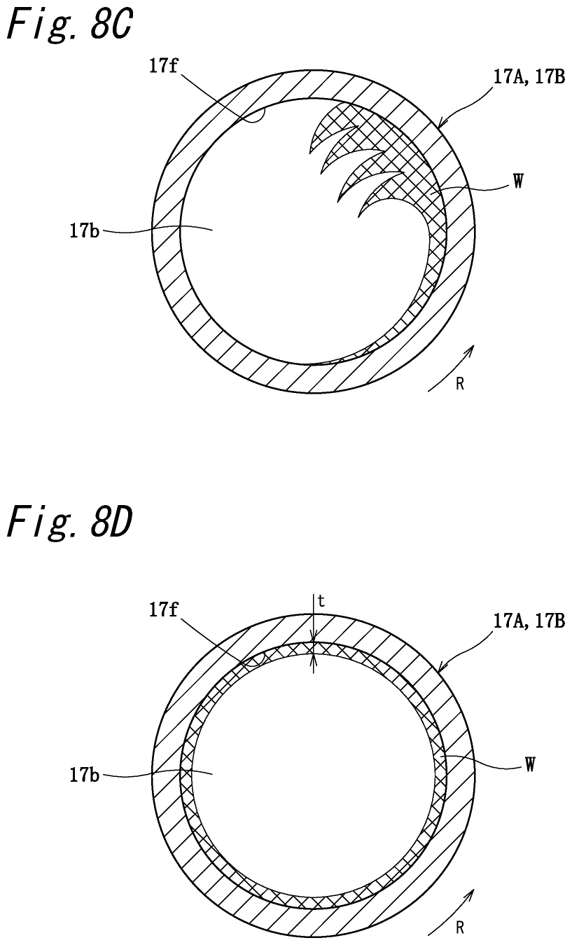

If the rotation speeds of the corrugating rolls 17A and 17B change, the magnitude of the centrifugal force acting on condensation liquid water W also changes. Therefore, as illustrated in FIGS. 8A to 8D, a state in which the remaining condensation liquid water W is adhered to a wall surface 17f defining the hollow portion 17b changes depending on the rotation speeds of the corrugating rolls 17A and 17B.

FIG. 8A illustrates a stopped state of the corrugating rolls 17A and 17B. In this case, the condensation liquid water W stays in the lower part of the hollow portion 17b and not is not adhered to the upper part of the wall surface 17f of the hollow portion 17b.

FIG. 8B illustrates a state in which the corrugating rolls 17A and 17B are rotating counterclockwise R at a low speed (for example, 150 m/min). In this case, the condensation liquid water W is unevenly adhered to the wall surface 17f on the lower right side of the hollow portion 17b, and is not adhered to the upper portion and the left side of the wall surface 17f . The speed is expressed as the base paper supply speed calculated by the rotation speed (r/min) and the diameter (for example, 500 mm) of the corrugating roll 17A.

FIG. 8C illustrates a state in which the corrugating rolls 17A and 17B are rotating counterclockwise R at a medium speed (for example, 250 m/min). In this case, the condensation liquid water W is unevenly adhered to the wall surface 17f on the right half of the hollow portion 17b , and is not adhered to the upper portion and the wall surface 17f on the left half.

FIG. 8D illustrates a state in which the corrugating rolls 17A and 17B are rotating counterclockwise R at a high speed (for example, 300 m/min). In this case, the condensation liquid water W is formed into a uniform film and is adhered to the entire surface of the wall defining the hollow portion 17b.

In the states illustrated in FIGS. 8A to 8C, which have a portion to which the condensation liquid water W is adhered and a portion to which the condensation liquid water W is not adhered, the temperature distribution in the circumferential direction of the corrugating rolls 17A and 17B becomes uneven, so that the heating of the starch glue SA may become uneven, resulting in poor adhesion. In the state illustrated in FIG. 8D to which the condensation liquid water is evenly adhered, the temperature distribution in the circumferential direction of the corrugating rolls 17A and 17B does not become uneven. However, if a film thickness t becomes excessively thick, heating of the corrugating rolls 17A and 17B by steam is hindered, so that insufficient heating may cause poor adhesion.

For example, in a medium-speed rotation state illustrated in FIG. 8C, the amount of water located below the hollow portion 17b is small, and the amount of water located above the hollow portion 17b is large. In this state, since the amount of the condensation liquid water W is small in a lower region where the tip of the siphon pipe 17e is located, it is difficult to discharge the condensation liquid water W. When the rotation is shifted to high speed in a state where there is a large amount of the condensation liquid water in the hollow portion 17b, the film thickness t due to the condensation liquid water W illustrated in FIG. 8D becomes thick, so that the heating of the corrugating rolls 17A and 17B by steam becomes insufficient.

Therefore, in the present embodiment, when shifting from the low-speed rotation state or the medium-speed rotation state to the high-speed rotation, the condensation liquid water W in the hollow portion 17b is sufficiently discharged, and sufficient steam is supplied into the hollow portion 17b . Then, the corrugating rolls 17A and 17B are heated to a temperature at which the starch glue SA can be gelatinized.

Specifically, as illustrated in FIG. 5, a pressure adjusting valve 55 is provided at the base portion 50a of the supply pipe 50, and on-off valves 60A and 60B are branched and connected to the branch portions 51b and 51c of the discharge pipe 51, respectively. In addition, speed sensors 63A and 63B (refer to FIG. 10) that detect the speed of the corrugating rolls 17A and 17B are disposed, and when the speed rises to the specified speed, high-temperature and high-pressure steam is forcibly supplied to the corrugating rolls 17A and 17B by the pressure adjusting valve 55 and the on-off valves 60A and 60B.

The pressure adjusting valve 55 is a flow adjusting valve that can adjust an opening area (steam supply pressure) in multiple stages between a fully open state in which the steam supply pipe 76 side and the corrugating rolls 17A and 17B sides communicate with each other and a fully closed state in which the communication is cut off. The pressure adjusting valve 55 includes a controller (PIC) 56 that adjusts the opening area of the valve, and a pressure gauge 57 that detects the pressure on the discharge side of the pressure adjusting valve 55. The controller 56 adjusts the opening area of the pressure adjusting valve 55 based on a detection value of the pressure gauge 57 so that steam is supplied from the steam supply pipe 76 to the hollow portion 17b at a designated pressure.

The on-off valves 60A and 60B are interposed in the branch connection pipes 61A and 61B, respectively. The on-off valves 60A and 6013 include a first end 60a connected to a first end 61a side of the branch connection pipes 61A and 61B and a second end 60b connected to a second end 61b side of the branch connection pipes 61A and 61B. The on-off valves 60A and 60B are solenoid valves that can be switched between an open state in which the first end 60a and the second end 60b communicate with each other and a closed state in which the communication is cut off.

The first end 61a of the branch connection pipes 61A and 61B is connected to the branch portions 51b and 51c , respectively, and is connected to the hollow portion 17b via the branch portions 51b and 51c, respectively. The second end 61b of the branch connection pipes 61A and 61B is connected to the inside of the hollow portion 17b and the second drain recovery pipe (low pressure portion) 78 having a lower pressure than the first drain recovery pipe 77. In the branch connection pipes 61A and 61B, a check valve 62, which allows the movement of fluid from the first end 61a to the second end 61b , and prevents the movement of the fluid in the opposite direction, is provided between the on-off valves 60A and 60B and the second end 61b.

The speed sensors 63A and 63B illustrated in FIG. 10 are arranged in the vicinity of the shaft portion 17c of the corrugating rolls 17A and 17B, respectively, and calculate the speeds of the individual corrugating rolls 17A and 17B by detecting the number of rotations of the shaft portion 17c per unit time. However, instead of detecting the speeds of the corrugating rolls 17A and 17B, the feeding speed of the base papers 2a and 4a in the paper feed units 12 and 14 illustrated in FIG. 1 or the feeding speed of the single-faced corrugated fiberboard 1a on the exit side of the corrugating roll 17A may be detected and based on the detected, and the speeds of the corrugating rolls 17A and 17B may be calculated based on the detected feeding speed, the diameters of the corrugating rolls 17A and 17B, and the gear ratio of the transmissions 19A and 19B.

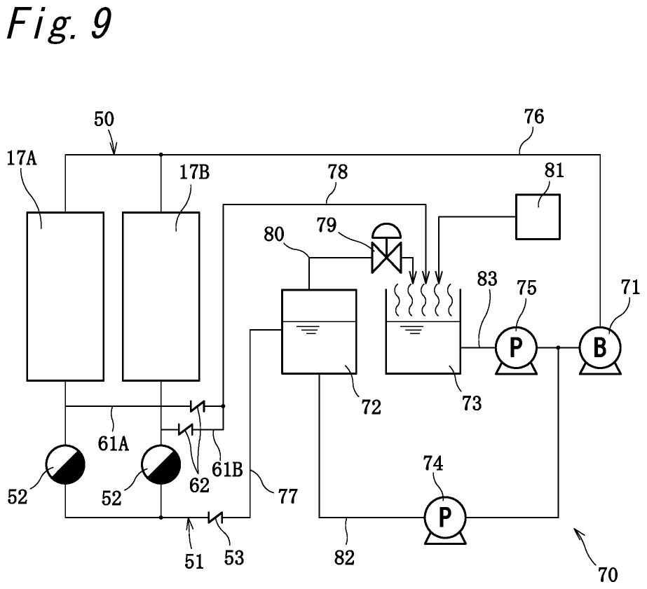

Next, a steam supply apparatus 70 connecting the supply pipe 50, the discharge pipe 51, and the branch connection pipes 61A and 61B will be described with reference to FIG. 9.

The steam supply apparatus 70 is a closed recovery type that supplies high-temperature and high-pressure steam while recovering condensation liquid water, and includes a boiler (steam supply unit) 71, a high-pressure recovery tank 72, a low-pressure recovery tank 73, and two pumps 74 and 75.

The boiler 71 discharges the water supplied from the pumps 74 and 75 as high-temperature and high-pressure steam. The steam supply pipe 76 is connected to the discharge port of the boiler 71, and the supply pipe 50 is connected to the steam supply pipe 76.

The high-pressure recovery tank 72 and the pump 74 are interposed in a first water supply pipe 82, one end of the first water supply pipe 82 is connected to the boiler 71, and a first drain recovery pipe 77 is connected the other end of the first water supply pipe 82 via the high-pressure recovery tank 72. The pressure (for example, 0.8 MPa) in the high-pressure recovery tank 72 is lower than the pressure in the hollow portion 17b.

The low-pressure recovery tank 73 and the pump 75 are interposed in a second water supply pipe 83, one end of the second water supply pipe 83 is connected to the boiler 71, and a second drain recovery pipe 78 is connected the other end of the second water supply pipe 83 via the low-pressure recovery tank 73. The pressure (for example, 0.1 MPa) in the low-pressure recovery tank 73 is lower than the pressure in the high-pressure recovery tank 72. That is, the inside of the first water supply pipe 82 has a lower pressure than the inside of the hollow portion 17b, and the inside of the second water supply pipe 83 has a lower pressure than the inside of the first water supply pipe 82. The low-pressure recovery tank 73 is further connected to the high-pressure recovery tank 72 via a pipe 80 provided with a pressure adjusting valve 79, and a water source 81 for supplying soft water.

The condensation liquid water recovered from the first drain recovery pipe 77 is temporarily stored in the high-pressure recovery tank 72, and the water in the high-pressure recovery tank 72 is supplied (reused) to the boiler 71 by the pump 74. The condensation liquid water containing steam recovered from the second drain recovery pipe 78 is supplied to the low-pressure recovery tank 73, and the water in the low-pressure recovery tank 73 is supplied (reused) to the boiler 71 by the pump 75.

Referring to FIG. 10, the corrugator 10 is electrically connected to the motors 18 and 31, the pressure adjusting valve 55, and the on-off valves 60A and 60B, and includes a control device (control unit) 65 for controlling these components. The control device 65 is formed of a single microcomputer or a plurality of microcomputers, and other electronic devices. The control device 65 includes a timer 66 for measuring the elapsed time. The control device 65 is electrically connected to speed sensors 63A and 63B for detecting the speeds of the motors 18 and 31 and an operation unit 67 for changing the speed. A rotary switch can be used for the operation unit 67.

The control device 65 controls the pressure adjusting valve 55 and the on-off valves 60A and 60B, and heats the starch glue applied to the corrugating medium base paper 4a via the upper corrugating roll 17A by the steam from the boiler 71. Further, as illustrated in FIG. 7, the control device 65 executes a steady operation of rotating the upper corrugating roll 17A, which most affects the gelatinization of the starch glue SA, at a set speed V1, a deceleration operation of rotating at a second set speed V2, and an acceleration operation of rotating at a third set speed V3, based on the input signal from the operation unit 67. The steady operation is executed after completing the acceleration operation. Similar to the upper corrugating roll 17A, the control device 65 also controls the speeds of other rolls of the lower corrugating roll 17B and the tension roll 30.

The steady operation is in a basic state in which the corrugated fiberboard sheet 1 is manufactured. The deceleration operation is executed by an operator who operates the operation unit 67 when the first liner base paper 2a or the corrugating medium base paper 4a is spliced or lot-changed. The acceleration operation is executed by the operator who operates the operation unit 67 after the completion of the paper splicing or the lot change. During the execution of the acceleration operation, when the rotation of the upper corrugating roll 17A is accelerated to a fourth set speed V4, the control device 65 forcibly supplies high-temperature and high-pressure steam into the hollow portion 17b . However, the shift from the deceleration operation to the acceleration operation may be performed by the control device 65 starting from the elapse of a predetermined time instead of the operation of the operation unit 67 by the operator.

The first set speed V1 during the steady operation is set in a range of 170 to 300 m/min. The second set speed V2 during the deceleration operation is set in a range of 100 to 150 m/min, which is slower than the first set speed. The third set speed V3 during the acceleration operation is set in a range of 170 to 300 m/min, which is faster than the second set speed. The fourth set speed V4 during the acceleration operation is set in a range of 150 to 160 m/min, which is faster than the second set speed V2 and slower than the third set speed V3. As described above, these set speeds V1 to V4 are expressed as the base paper supply speed calculated by the rotation speed and diameter of the corrugating roll 17A.

In a case of the paper splicing, the first set speed V1 and the third set speed V3 may be the same as or may be different from each other as illustrated by a broken line in FIG. 7. However, when the steady operation is executed after completing the acceleration operation, the rotation of the upper corrugating roll 17A is returned to the first set speed V1. In a case of the lot change, the third set speed V3 is set within the predetermined range depending on the grade and basis weight of the base papers 2a and 4a, and thus is often different from the first set speed V1. In this case, the first set speed V1 of the upper corrugating roll 17A in the steady operation is updated to the same value as that of the third set speed V3.

As illustrated in FIG. 8D, the first set speed V1 and the third set speed V3 are the speeds at which the condensation liquid water W is adhered to the entire circumference of the wall surface 17f of the hollow portion 17b due to the centrifugal force. As illustrated in FIG. 8B or FIG. 8C, the second set speed V2 is the speed at which the condensation liquid water W is adhered to a part of the wall surface 17f of the hollow portion 17b. As illustrated in FIG. 8C, the fourth set speed V4 is a speed at which not only the condensation liquid water is not adhered to a part of the wall surface 17f of the hollow portion 17b, but also the condensation liquid water W adhered to the lower region of the hollow portion 17b is reduced.

In the steady operation, the control device 65 controls the on-off valves 60A and 60B to be in a closed state, and supplies steam to the hollow portion 17b at a first set pressure P1 by the pressure adjusting valve 55. For example, the maximum pressure that steam can be supplied by the boiler 71 is 1.2 MPa or more and 2.0 MPa, and the first set pressure P1 is set to 1.0 MPa or more and 1.2 MPa. Further, as illustrated in FIG. 7, the upper corrugating roll 17A is rotated by the motor 18 at the first set speed V1, and the crimping member 29 is rotated by the motor 31 at the corresponding speed.

By supplying the steam to the hollow portion 17b at the first set pressure P1 by the pressure adjusting valve 55 and gelatinizing the starch glue SA via the corrugating rolls 17A and 17B, the corrugating medium base paper 4a can be reliably adhered to the first liner base paper 2a . The water condensed in the hollow portion 17b is discharged through the steam trap 52 due to the differential pressure between the hollow portion 17b and the first drain recovery pipe 77. Therefore, it is possible to suppress heat inhibition due to the condensation liquid water in the hollow portion 17b and prevent poor adhesion between the first liner base paper 2a and the corrugating medium base paper 4a due to insufficient heating.

The deceleration operation is executed following the steady operation. That is, when a signal indicating speed reduction is input from the operation unit 67 during the execution of the steady operation, the control device 65 shifts from the steady operation to the deceleration operation.

In the deceleration operation, the control device 65 controls the on-off valves 60A and 60B to remain in the closed state, and maintains the steam supply at the first set pressure P1 by the pressure adjusting valve 55. Further, as illustrated in FIG. 7, the motor 18 rotates the upper corrugating roll 17A at the second set speed V2, and the motor 31 rotates the crimping member 29 at the corresponding speed. At this time, the speed of the upper corrugating roll 17A is gradually decelerated from the first set speed V1 to the second set speed V2, and then maintained at the second set speed V2.

The acceleration operation is executed following the deceleration operation. That is, when a signal indicating a speed increase is input from the operation unit 67 during the execution of the deceleration operation, the control device 65 shifts from the deceleration operation to the acceleration operation.

In the acceleration operation, as illustrated in FIG. 7, the control device 65 rotates the upper corrugating roll 17A at the third set speed V3 by the motor 18, and rotates the crimping member 29 at the corresponding speed by the motor 31. At this time, the speed of the upper corrugating roll 17A is gradually accelerated from the second set speed V2 to the third set speed V3, and then maintained at the third set speed V3.

In the acceleration operation, the control device 65 controls the pressure adjusting valve 55 and the on-off valves 60A and 60B as follows. First, in the first stage, the on-off valves 60A and 60B are remain in the closed state, and the pressure adjusting valve 55 maintains the steam supply at the first set pressure P1. Subsequently, when the speed of the upper corrugating roll 17A is accelerated to the fourth set speed V4, the control device 65 switches the on-off valves 60A and 60B from the closed state to the open state in the second stage, and supplies steam to the hollow portion 17b at a second set pressure P2 by the pressure adjusting valve 55. For example, the second set pressure P2 is set to 1.5 MPa or more and 1.9 MPa.

As a result, even if the amount of condensation liquid water remaining in the hollow portion 17b of the corrugating rolls 17A and 17B increases, since the condensation liquid water containing steam in the hollow portion 17b can be forcibly discharged through the on-off valves 60A and 60B, and high-temperature and high-pressure steam can be supplied to the hollow portion 17b, the corrugating rolls 17A and 17B can be quickly heated to the desired amount of heat. Therefore, since the starch glue SA applied to the corrugating medium base paper 4a can be reliably heated via the corrugating rolls 17A and 17B, poor adhesion between the first liner base paper 2a and the corrugating medium base paper 4a can be suppressed.

When the rotation of the upper corrugating roll 17A is accelerated to the fourth set speed V4, the control device 65 measures the time by the timer 66. Then, when a predetermined time St elapses, the acceleration operation is completed and the steady operation is started. An example of the set time for executing the second stage is shown below.

TABLE 1
Unit: sec

| Basis weight of | | | | |
|---|---|---|---|---|
| corrugating medium | | | | |
| (g/m²) | 120 or | 121 to | 161 to | 181 or |
| Feeding speed (m/min) | less | 160 | 180 | more |
| 179 or less | 0 | 5 | 7 | 9 |
| 180 to 199 | 0 | 6 | 8 | 10 |
| 200 to 229 | 0 | 7 | 8 | 11 |
| 230 to 279 | 0 | 8 | 9 | 12 |
| 280 or more | 0 | 9 | 10 | 15 |

As shown in Table 1 above, the set time St at the second stage is set based on the feeding speed Vb of the corrugating medium base paper 4a by the upper corrugating roll 17A and the basis weight of the corrugating medium base paper 4a. The feeding speed Vb is divided into five stages in a range of 179 m/min or less to 280 m/min or more, and the basis weight is divided into four stages in a range of 120 g/m² or less to 181 g/m² or more. The set time St is set so as to increase as the feeding speed Vb increases and as the basis weight increases.

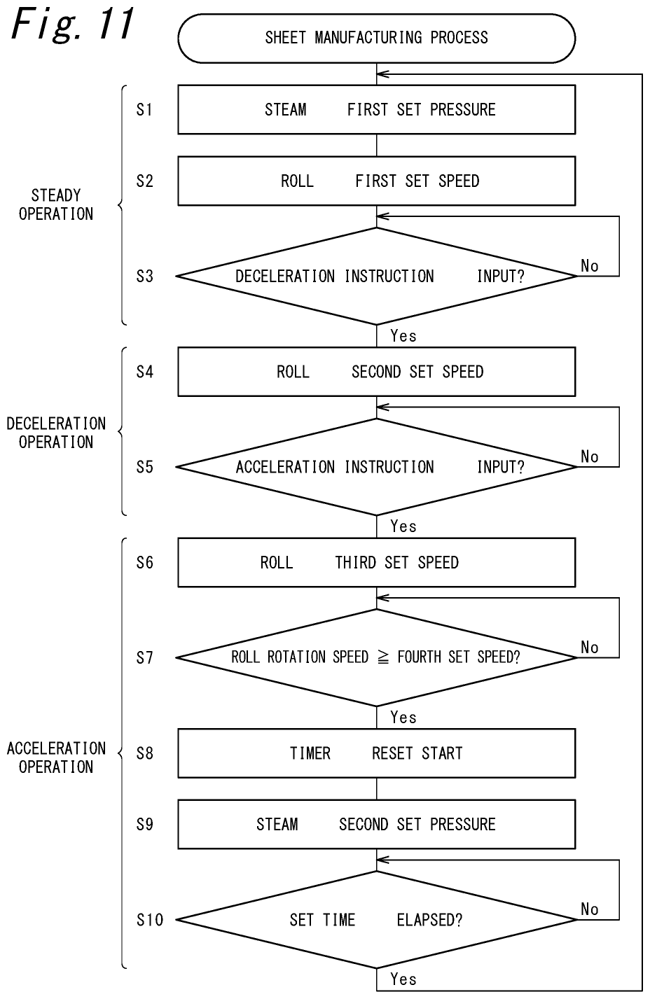

Next, the control by the control device 65 will be specifically described with reference to FIG. 11.

When the manufacturing of the corrugated fiberboard sheet 1 is started, in step S1, the control device 65 controls the on-off valves 60A and 60B in a closed state and adjusts the opening degree of the pressure adjusting valve 55 so that steam is supplied to the hollow portion 17b at the first set pressure P1. Subsequently, in step S2, the upper corrugating roll 17A is rotated at the first set speed V1 (refer to FIG. 7), and other rolls of the lower corrugating roll 17B and the tension roll 30 are also rotated at the corresponding set speeds so that the first liner base paper 2a and the corrugating medium base paper 4a are fed at the feeding speeds Val and Vb1 (refer to FIG. 6).

Subsequently, the control device 65 waits in step S3 until a deceleration instruction is input from the operation unit 67. Then, when the deceleration instruction is input, in step S4, the upper corrugating roll 17A is rotated at the second set speed V2 (refer to FIG. 7), and other rolls of the lower corrugating roll I7B and the tension roll 30 are also rotated at the corresponding set speeds so that the first liner base paper 2a and the corrugating medium base paper 4a are fed at the feeding speeds Va2 and Vb2 (refer to FIG. 6).

Subsequently, the control device 65 waits in step S5 until an acceleration instruction is input from the operation unit 67. Then, when the acceleration instruction is input, in step S6, the upper corrugating roll 17A is rotated at the third set speed V3 (refer to FIG. 7), and other rolls of the lower corrugating roll 17B and the tension roll 30 are also rotated at the corresponding set speeds so that the first liner base paper 2a and the corrugating medium base paper 4a are fed at the feeding speeds Va3 and Vb3 (refer to FIG. 6).

Subsequently, in step S7, the control device 65 waits until the detection speed by the speed sensor 63A becomes the fourth set speed V4 or higher. Then, when the speed of the upper corrugating roll 17A becomes the fourth set speed V4 or higher, the timer 66 is reset and started in step S8. After that, in step S9, the on-off valves 60A and 60B are switched to the open state, and the opening degree of the pressure adjusting valve 55 is adjusted so that steam is supplied to the hollow portion 17b at the second set pressure P2.

Subsequently, the control device 65 waits until the set time St elapses in step S10, and returns to step Si when the set time elapses. That is, the on-off valves 60A and 60B are set to be in the closed state, and the opening degree of the pressure adjusting valve 55 is adjusted so that steam is supplied to the hollow portion 17b at the first set pressure P1.

The corrugator 10 configured in this way has the following features.

Since the paper splicing and the lot change are performed in a state where the rotation of the corrugating rolls 17A and 17B corresponding to the feeding speed of the base papers 2a and 4a is decelerated without stopping the corrugating rolls 17A and 17B, it is possible to suppress a decrease in the production efficiency of the corrugated fiberboard sheet 1.

In the acceleration operation, the on-off valves 60A and 60B are switched from the closed state to the open state, and steam is supplied to the corrugating rolls 17A and 17B at the second set pressure P2 of high pressure by the pressure adjusting valve 55. Therefore, even if the amount of condensation liquid water increases in the hollow portion 17b of the corrugating rolls 17A and 17B, the condensation liquid water containing steam can be forcibly discharged (purged) through the on-off valves 60A and 60B, and the corrugating rolls 17A and 17B can be quickly heated to a desired amount of heat by high-temperature and high-pressure steam. As a result, since the starch glue SA applied to the corrugating medium base paper 4a can be reliably heated via the corrugating rolls 17A and 17B, poor adhesion between the first liner base paper 2a and the corrugating medium base paper 4a can be suppressed. In addition, it is possible to increase the operating speed of the corrugator 10, that is, to improve the productivity of the corrugated fiberboard sheet 1.

In the acceleration operation, when the upper corrugating roll 17A is accelerated up to the fourth set speed V4, the open/closed state of the on-off valves 60A and 60B and the opening degree of the pressure adjusting valve 55 are switched. Further, the control device 65 completes the acceleration operation when a predetermined time St elapses, and executes the steady operation. Therefore, since the excessive supply of steam can be suppressed, it is possible to prevent an increase in the manufacturing cost of the corrugated fiberboard sheet 1.

The corrugated fiberboard sheet manufacturing apparatus 10 of the present invention is not limited to the configuration of the above embodiment, and various modifications can be made.

For example, the acceleration operation by the control device 65 may be completed when the rotation of the upper corrugating roll 17A is accelerated to the third set speed V3, or is accelerated to a fifth set speed which is faster than the fourth set speed and slower than the third set speed V3.

### REFERENCE SIGNS LIST

Corrugated fiberboard sheet, 1a: Single-faced corrugated fiberboard, 1b: Double-faced corrugated fiberboard, 2: Outer liner, 2a : First liner base paper, 3: Inner liner, 3a: Second liner base paper, 4: Corrugating medium, 4a : Corrugating medium base paper, 5: Projection, 6: Recess, 10: Corrugator (corrugated fiberboard sheet manufacturing apparatus), 12: First paper feed unit, 12a : Mill roll stand, 14: Second paper feed unit, 14a: Mill roll stand, 16: Single facer, 17A, 17B: Corrugating roll, 17a: Teeth, 17b: Hollow portion, 17c: Shaft portion, 17d: Communication hole, 17e: Siphon pipe, 17f: Wall surface, 18: Motor (drive unit), 19A; 19B: Transmission, 22: Glue unit, 23: Container, 24: Application roll, 25: Doctor roll, 28: Crimping portion, 29: Crimping member, 30: Tension roll, 31: Motor, 34: Storage part, 36: Third paper feed unit, 36a : Mill roll stand, 38: Glue unit, 40: Heating roll, 41: Guide roll, 44: Double facer, 50: Supply pipe, 50a: Base portion, 50b: First branch portion, 50c: Second branch portion, 51: Discharge pipe, 51a: Base portion, 51b: First branch portion, 51c : Second branch portion, 52: Steam trap, 53: Check valve, 55: Pressure adjusting valve, 56: Controller, 57: Pressure gauge, 60A; 60B: On-off valve, 60a; First end, 60b: Second end, 61A; 61B: Branch connection pipe, 61a: First end, 61b : Second end, 62: Check valve, 63A; 63B Speed sensor, 65: Control device (control unit), 66: Timer, 67: Operation unit, 70: Steam supply apparatus, 71: Boiler (steam supply unit), 72: High-pressure recovery tank, 73: Low-pressure recovery tank, 74: Pump, 75: Pump, 76: Steam supply pipe, 77: First drain recovery pipe, 78: Second drain recovery pipe (low pressure portion), 79: Pressure adjusting valve, 80: Pipe, 81: Water source, 82: First water supply pipe, 83: Second water supply pipe, SA: Starch glue, W: Condensation liquid water

1. A corrugated fiberboard sheet manufacturing apparatus comprising:
a corrugating roll that has a hollow portion capable of retaining steam, forms a plurality of projections and recesses alternately on a strip-shaped corrugating medium base paper, and crimps the corrugating medium base paper onto a strip-shaped liner base paper tofeed;
a drive unit that rotates the corrugating roll;
a glue unit that applies glue to a top of the projection of the corrugating medium base paper for adhering to the liner base paper;
a pressure adjusting valve that communicates with the hollow portion of the corrugating roll and adjusts a supply pressure of steam supplied from a steam supply unit to the hollow portion;
a steam trap that communicates with the hollow portion and discharges the condensation liquid water in the hollow portion;
an on-off valve that has a first end that communicates with the hollow portion and a second end that communicates with a low pressure portion having a pressure lower than the pressure inside the hollow portion, and is capable of switching between an open state in which a first end side and a second end side communicate with each other and a closed state in which communication between the first end side and the second end side is cut off; and
a control unit that controls the drive unit, the pressure adjusting valve, and the on-off valve, and feeds the corrugating medium base paper while heating the glue applied to the corrugating medium base paper with the steam through the corrugating roll, wherein
the control unit is capable of executing a steady operation in which the corrugating roll is rotated at a first set speed by the drive unit, subsequently, executing a deceleration operation by the drive unit in which the corrugating roll is decelerated to a second set speed slower than the first set speed, and then executing an acceleration operation in which the corrugating roll is accelerated to a third set speed faster than the second set speed,
in the steady operation, the control unit controls the pressure adjusting valve so that the on-off valve is in a closed state and the steam is supplied to the hollow portion at a first set pressure,
in the deceleration operation, the control unit maintains a state of the on-off valve and the pressure adjusting valve, and
in the acceleration operation, the control unit switches the on-off valve from a closed state to an open state, and adjusts the pressure adjusting valve so that the steam is supplied to the hollow portion at a second set pressure higher than the first set pressure.

2. The corrugated fiberboard sheet manufacturing apparatus according to claim 1,
wherein during the acceleration operation, when the rotation of the corrugating roll by the drive unit is accelerated to a fourth set speed which is faster than the second set speed and slower than the third set speed, the control unit switches a state of the on-off valve and adjusts an opening degree of the pressure adjusting valve.

3. The corrugated fiberboard sheet manufacturing apparatus according to claim 2,
wherein the control unit completes the acceleration operation and returns to the steady operation when a predetermined time elapses after the rotation of the corrugating roll is accelerated to the fourth set speed.

4. The corrugated fiberboard sheet manufacturing apparatus according to claim 1, further comprising:
an operation unit that causes the control unit to execute the deceleration operation and the acceleration operation, respectively, during the execution of the steady operation.

5. The corrugated fiberboard sheet manufacturing apparatus according to claim 2, further comprising:
an operation unit that causes the control unit to execute the deceleration operation and the acceleration operation, respectively, during the execution of the steady operation.

6. The corrugated fiberboard sheet manufacturing apparatus according to claim 3, further comprising:
an operation unit that causes the control unit to execute the deceleration operation and the acceleration operation, respectively, during the execution of the steady operation.
